(19) United States
(12) Patent Application Publication
(10) Pub. No.: US 2001/0040373 A1
(43) Pub. Date: Nov. 15, 2001

(54) Document having an area with marks to resemble shading at a distance

(75) Inventors: John C. Golemo, Acworth, GA (US); Kathy V. Maples, Knoxville, TN (US)

Correspondence Address: R. Kent Roberts, Hodgson, Russ, Andrews, Woods & Goodyear, LLp, One M & T Plaza Suite 2000, Buffalo, NY, 14203-2391, US

(73) Assignee: golemo

(21) Appl. No.: 09/510,865

(22) Filed: Feb. 23, 2000

(51) Int. Cl. B42D 15/00

(52) U.S. Cl. 283/93; 283/114

(57) ABSTRACT

A document has a substrate with a first side. The first side has a first area within which the substrate is a first color. The document also has a plurality of marks on the substrate within a second area. The second area is smaller than the first area and is within the first area. Each mark is a different color from the first color. The density and size of the marks is such that at a distance of about twenty inches, the first area appears to the human eye to have a shaded area corresponding to the second area, as well as an unshaded area corresponding to a portion of the first area not occupied by the second area. At a distance of about eight inches, the second area appears to the human eye to have a plurality of marks.

The method of making the document begins by providing a substrate, as described above. Next, a plurality of marks are printed on the substrate within the second area.

### BACKGROUND OF THE INVENTION

1. Field of the Invention

The present invention relates generally to printed documents. More specifically, the present invention relates to a document having an area with marks sized and spaced apart such that at a distance, the area appears to be shaded.

2. Discussion of Related Art

In the prior art, there are documents having a printed pattern. For example, one such prior art document has a printed background pattern and warning printed matter interspersed with blank areas of a substrate to provide a distinct intermeshed pattern so that the warning printed matter is indistinguishable from the printed background by the human eye. The printed background comprises a number of parallel lines of a size such that they will be resolved by a photocopy machine, while the warning printed matter comprises geometric elements (typically circular dots) of a size less than that which can be resolved by a photocopy machine. The dots are disposed in a geometric continuation of at least some of the lines from the printed background, and are configured to form invalidating indicia of the document if copied by a photocopy machine. The printed background pattern and warning printed matter typically have a density of less than 20%, such as about 7-11%. The warning printed matter may be in the form of at least one outline letter configuration, in which case second lines, making an angle of about 20-70% with respect to the first lines, are provided within the outline letter configuration.

Such prior art documents have disadvantages. For example, they do not provide a document that has an area with marks and an adjacent area without marks, wherein the area having the marks can receive written text, and when sent by facsimile machine, the written text on the received facsimile appears from a comfortable reading distance to be within a shaded area.

### SUMMARY OF THE INVENTION

Accordingly, it is an object of the present invention to provide a document having an area with marks therein, the marks being sized and spaced apart such that at a distance, the area appears to be shaded.

The foregoing objective is realized by the present invention, which is a document and a method of making the document. The document according to the present invention has a substrate having a first side with a first area within which the substrate is a first color. The document also has a plurality of marks on the substrate within a second area. The second area is smaller than the first area and is within the first area. Each mark is a different color from the first color. The density and size of the marks is such that at a distance of about twenty inches, the first area appears to the human eye to have a shaded area corresponding to the second area, as well as an unshaded area corresponding to a portion of the first area not occupied by the second area. At a distance of about eight inches, the second area appears to the human eye to have a plurality of marks.

The method of making the document begins by providing a substrate, as described above. Next, a plurality of marks are printed on the substrate within the second area.

Other objects and advantages of the present invention will become apparent to those skilled in the art from the following detailed description read in conjunction with the attached drawings and claims appended hereto.

### BRIEF DESCRIPTION OF THE DRAWINGS

For a fuller understanding of the nature and objects of the invention, reference should be made to the following detailed description taken in conjunction with the accompanying drawings, in which:

FIGS. 1 and 2 show a document according to the present invention;

FIG. 3 is an enlarged view of the area labeled E2 on FIG. 2;

FIG. 4 is an enlarged view of the area labeled E3 on FIG. 3;

FIG. 5 is an enlarged view of a mark according to the present invention; and

FIG. 6 shows steps of a method according to the present invention.

### BEST MODE FOR CARRYING OUT THE INVENTION

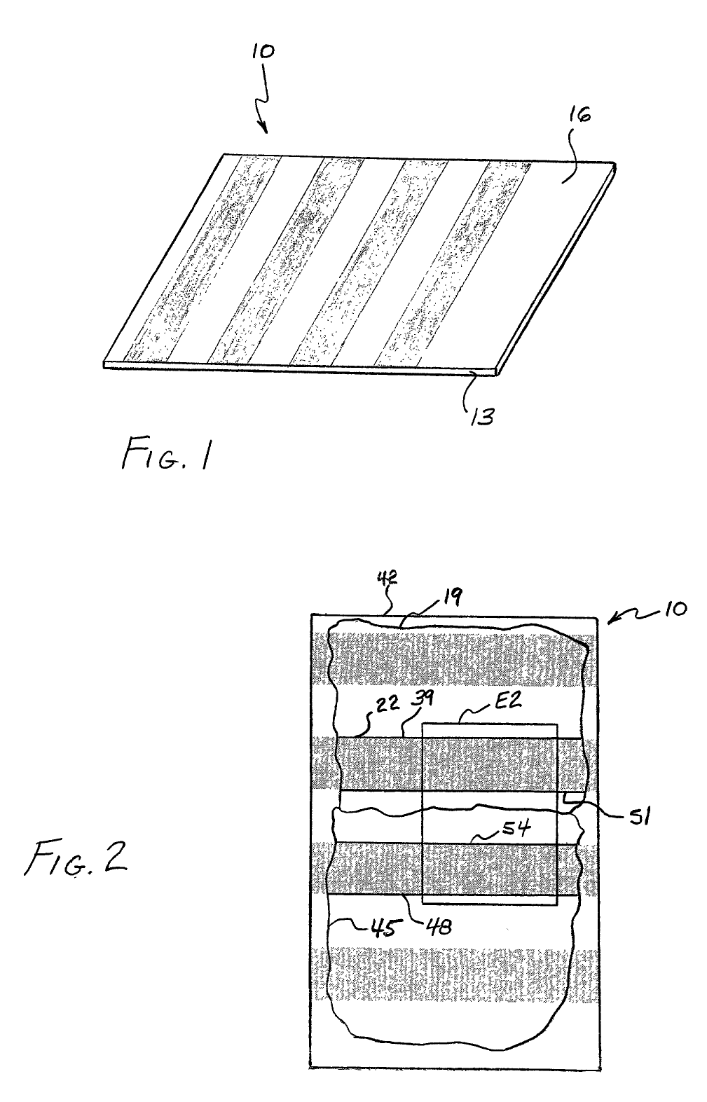

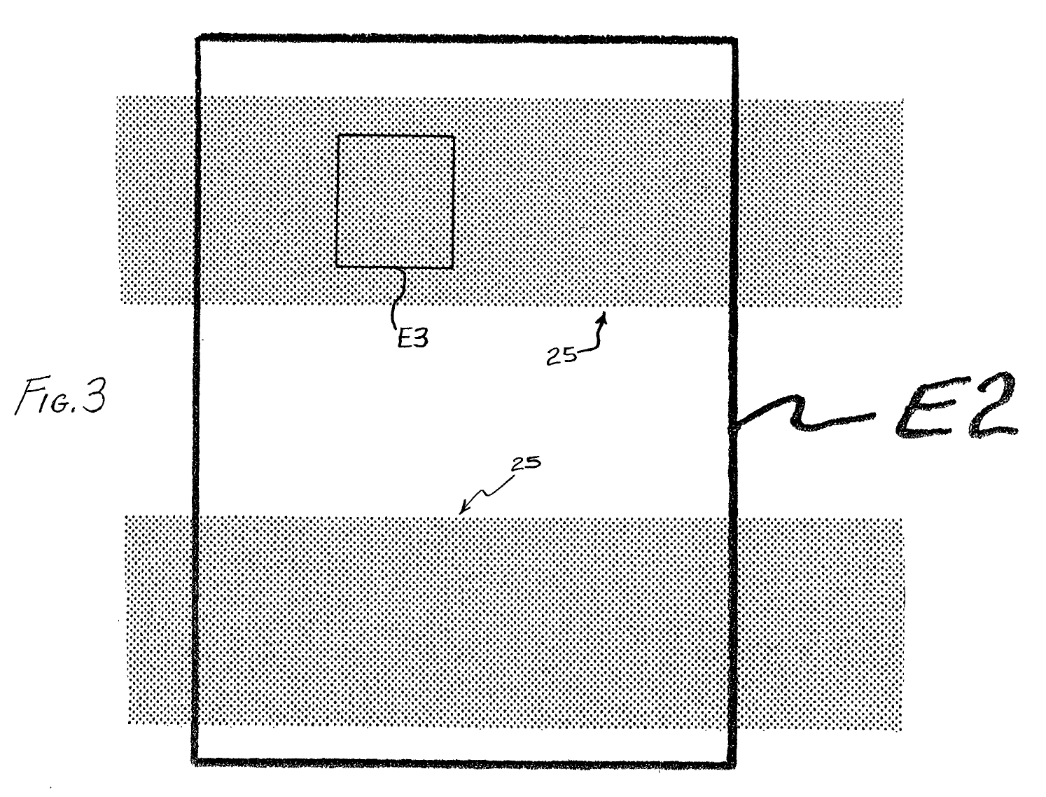

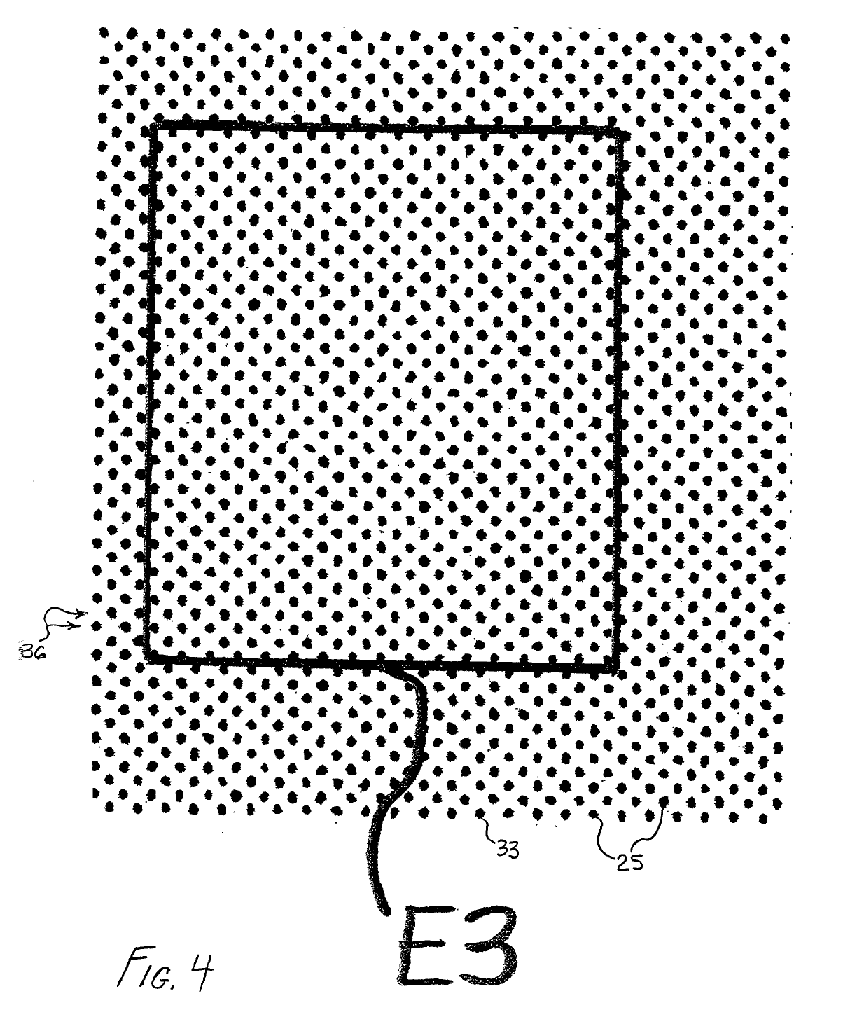

FIGS. 1 and 2 show a document 10 according to the present invention. The document 10 has a substrate 13 having a first side 16 and a first area 19 on the first side 16 within which the substrate 13 is a first color. The first color may be, for example, white, gray, blue, yellow or red. Within the first area 19 is a second area 22. The second area 22 is smaller than the first area 19. As best seen in FIGS. 3 and 4, a plurality of marks 25 are on the substrate 13 within the second area 22, and each mark 25 is a color different from the first color. For example, the marks 25 may each be the same color, such as black, blue or red. Alternatively, some of the marks 25 may be one color while other marks 25 are another color.

The distance between marks 25 (herein referred to as the “density”) and the size of the marks 25 is such that at a distance of about twenty inches or more, the second area 22 appears to the human eye to be a shaded area relative to the first area 19, i.e. the human eye can not distinguish the marks 25 in the second area 22. In addition, at a distance of about eight inches or less, the second area 22 appears to the human eye to have therein a plurality of marks 25, i.e. the human eye can distinguish the marks 25 in the second area 22.

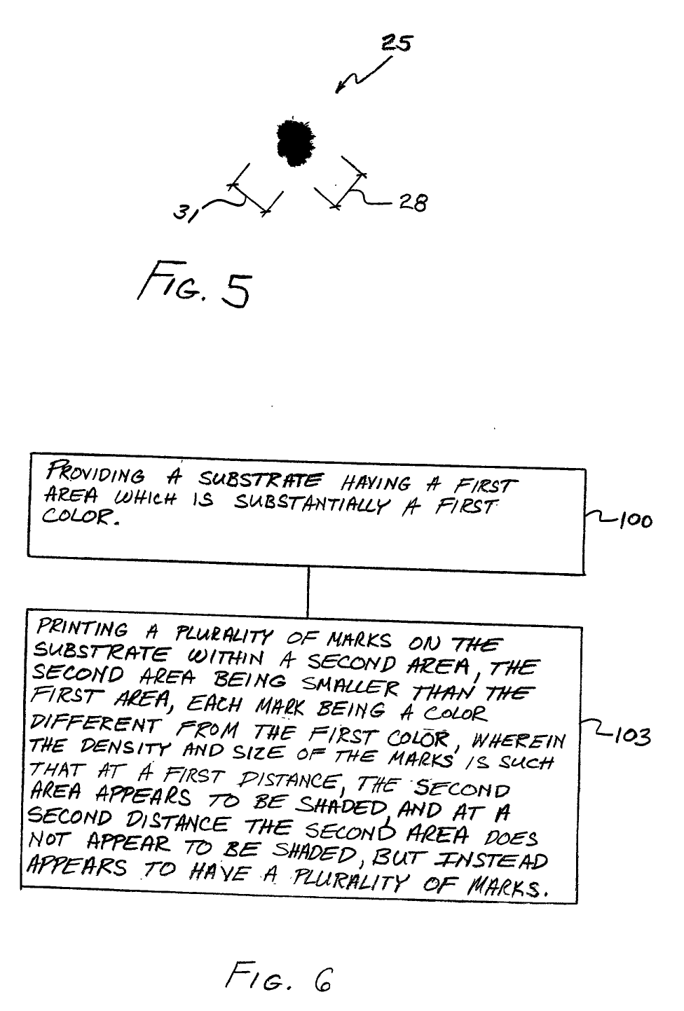

As shown in FIGS. 4 and 5, in one embodiment of the present invention, the marks 25 in the second area 22 have a first width 28 between about 0.003 inches and 0.005 inches, and a second width 31 between about 0.003 inches and 0.005 inches. The first width 28 and the second width 31 are substantially perpendicular to each other. The marks 25 may have a perimeter 33 that is preferably substantially circular, but other shapes may be used.

In one embodiment of the present invention, the plurality of marks 25 are spaced apart from each other to provide a density of between about 3,500 marks per square inch and about 18,500 marks per square inch. It is preferred that the marks 25 be distributed evenly throughout the second area 22 in order to give a consistent appearance of shading. One means of providing the marks 25 evenly throughout the second area 22 is to arrange the marks 25 in a plurality of straight rows 36 each row 36 having between 60 marks per inch and 135 marks per inch.

In the embodiment of the present invention shown in FIGS. 1 and 2, the second area 22 is substantially rectangular. Preferably, the second area 22 is oriented on the substrate 13 so a first side 39 of the second area 22 is substantially parallel to a first edge 42 of the substrate 13.

As shown in FIG. 2, the substrate 13 may have a third area 45 adjacent to the first area 19. Preferably, the third area 45 resembles the first area 19. In particular, the substrate 13 is the first color within the third area 45, and within the third area 45 is a fourth area 48 resembling the second area 22. The second area 22 and the fourth area 48 may each be substantially rectangular in shape, and may each be oriented so a second side 51 of the second area 22 is substantially parallel to a side 54 of the fourth area 48. In this manner, the second area 22 and the fourth area 48 appear from a distance to be parallel shaded areas with an unshaded area between them.

The present invention includes a method of making the document 10 described above. FIG. 6 shows steps of a method according to the present invention. In the method, a substrate is provided (step 100). The substrate has a first area which is substantially a first color. Then, a plurality of marks are printed (step 103) on the substrate within a second area. The second area is smaller than the first area and within the first area. Each mark is a color different from the first color. The density and size of the marks is such that at a distance of about twenty inches or more, the first area appears to the human eye to have a shaded area corresponding to the second area. Furthermore, at a distance of about twenty inches or more, the first area appears to the human eye to have an unshaded area corresponding to a portion of the first area not occupied by the second area. The density and size of the marks is such that at a distance of about eight inches or less, the second area appears to the human eye to have therein a plurality of marks.

It will be apparent to those skilled in the art that a document according to the present invention provides advantages not achieved by the prior art. For example, the marks can be detected by a standard facsimile machine. A person can write a message within the area having the marks and when such a document is sent by facsimile, the received facsimile appears, when held at a comfortable reading distance, to have a shaded area with the written message therein.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A document, comprising:
a substrate having a first side, the first side having a first area within which the substrate is a first color;
a plurality of marks on the substrate within a second area, the second area being smaller than the first area and within the first area, each mark being a color different from the first color and having a first width between about 0.003 inches and 0.005 inches and a second width between about 0.003 inches and 0.005 inches, the first width and the second width being substantially perpendicular to each other, and wherein the plurality of marks are spaced apart from each other to provide a density of between about 3,500 marks per square inch and about 18,500 marks per square inch.

2. The document of claim 1 wherein some of the marks have a perimeter that is substantially circular.

3. The document of claim 1 wherein the marks are arranged in a plurality of straight rows.

4. The document of claim 3, wherein the density of marks is such that each row has between 60 marks per inch and 135 marks per inch.

5. The document of claim 1, wherein the second area is substantially rectangular.

6. The document of claim 5, wherein the second area is oriented on the substrate so that a first side of the second area is substantially parallel to a first edge of the substrate.

7. The document of claim 1, wherein the substrate has a third area adjacent to the first area, the substrate being the first color within the third area, and within the third area is a fourth area resembling the second area, the fourth area being smaller than the third area.

8. The document of claim 7, wherein the second area and the fourth area are each substantially rectangular in shape.

9. The document of claim 8, wherein a side of the second area is substantially parallel to a side of the fourth area.

10. A document, comprising:
a substrate having a first side, the first side having a first area within which the substrate is a first color;
a plurality of marks on the substrate within a second area, the second area being smaller than the first area and within the first area, each mark being a different color from the first color, the density and size of the marks being such that at a distance of about twenty inches, the first area appears to the human eye to have a shaded area corresponding to the second area and an unshaded area corresponding to a portion of the first area not occupied by the second area, while at a distance of about eight inches, the second area appears to the human eye to have therein a plurality of marks.

11. The document of claim 10 wherein some of the marks have a perimeter that is substantially circular.

12. The document of claim 10 wherein the marks are arranged in a plurality of straight rows.

13. The document of claim 12 wherein the density of marks is such that each row has between 60 marks per inch and 135 marks per inch.

14. The document of claim 10, wherein each mark has a first width between about 0.003 inches and 0.005 inches and a second width between about 0.003 inches and 0.005 inches, the first width and the second width being substantially perpendicular to each other.

15. The document of claim 10, wherein the plurality of marks are spaced apart from each other to provide a density of between about 3,500 marks per square inch and about 18,500 marks per square inch.

16. The document of claim 10, wherein the second area is substantially rectangular.

17. The document of claim 16, wherein the second area is oriented on the substrate so that a first side of the second area is substantially parallel to a first edge of the substrate.

18. The document of claim 10, wherein the substrate has a third area adjacent to the first area, the substrate being the first color within the third area, and within the third area is a fourth area resembling the second area, the fourth area being smaller than the third area.

19. The document of claim 18, wherein the second area and the fourth area are each substantially rectangular in shape.

20. The document of claim 19, wherein a side of the second area is substantially parallel to a side of the fourth area.

21. A method of making a document, comprising:
providing a substrate having a first area which is substantially a first color; and
printing a plurality of marks on the substrate within a second area, the second area being smaller than the first area and within the first area, each mark being a color different from the first color, and wherein the density and size of the marks is such that at a distance of about twenty inches, the first area appears to the human eye to have a shaded area corresponding to the second area and an unshaded area corresponding to a portion of the first area not occupied by the second area, while at a distance of about eight inches, the second area appears to the human eye to have therein a plurality of marks.
